(19) United States
(12) Patent Application Publication
(10) Pub. No.: US 2025/0138470 A1
(43) Pub. Date: May 1, 2025

(54) ELECTROSTATIC COLLECTING DEVICE

(71) Applicant: CANON KABUSHIKI KAISHA, Tokyo (JP)

(72) Inventors: YUKI NISHIZAWA, Kanagawa (JP); TOMOAKI NAKAI, Shizuoka (JP); JUNICHI SEKIYAMA, Tokyo (JP)

(21) Appl. No.: 18/929,867

(22) Filed: Oct. 29, 2024

(30) Foreign Application Priority Data
Oct. 31, 2023 (JP) 2023-187242

(51) Int. Cl. G03G 21/00

(52) U.S. Cl. CPC G03G 21/0047; G03G 21/0023; G03G 21/0035; G03G 21/0076; G03G 2221/001; G03G 2221/0042; G03G 2221/0073

(57) ABSTRACT

An electrostatic collecting device includes a rotatable collecting body including a collecting member for forming a collecting portion in contact with an object-to-be-cleaned and formed of an insulator, wherein the rotatable collecting body rubs the object-to-be-cleaned in the collecting portion with the collecting member by rotation thereof, and collects, in the collecting member, a substance-to-be-collected from the object-to-be-cleaned moved relative to the collecting portion; a removing member for removing the substance-to-be-collected from the collecting member; and a charge-removing member provided opposed to the object-to-be-cleaned on a side downstream of the collecting portion with respect to a movement direction of the object-to-be-cleaned relative to the collecting portion. The charge-removing member constitutes at least a part of at least one of the rotatable collecting body and the removing member. The charge-removing member is electrically connected to an electric conductor which is in non-contact with the object-to-be-cleaned.

### FIELD OF THE INVENTION AND RELATED ART

The present invention relates to an electrostatic collecting device for cleaning a substance-to-be-collected from an object-to-be-cleaned.

Conventionally, in various manufacturing facilities, industrial products, or domestic cleaners and the like, a technique for cleaning fine particles by using an electrostatic depositing force is proposed. Herein, “fine particles” refers to, for example, toner and paper powder in an electrophotographic image forming apparatus, dust (dirt) in the manufacturing facilities or at home, and the like.

For example, in Japanese Laid-Open Patent Application (JP-A) No. Hei 1-6989, an electrostatic collecting device (cleaning device) for cleaning toner on an electrostatic latent image bearing member in an electrophotographic image forming apparatus by using an electrostatic depositing force is disclosed. In Japanese Patent No. 4886097, an electrostatic collecting device (cleaning device) for cleaning dust (dirt) on a surface of a glass substrate, a printed circuit board (PCB, PCBA, or the like), a film, a sheet, a plastic plate, or the like by using the electrostatic depositing force is disclosed. In JP-A No. 2015-84993, an electrostatic collecting device (cleaning device) for cleaning dust (dirt) on a floor surface by using the electrostatic depositing force is disclosed.

These electrostatic collecting devices first electrostatically collect, on a rotatable collecting body, a substance-to-be-collected on an object-to-be-cleaned by rubbing the substance-to-be-collected with the rotatable collecting body and recover the substance-to-be-collected, electrostatically deposited on the rotatable collecting body, by a rotatable recovering body, or the like.

As the rotatable collecting body, a brush roller provided with raising (nap), constituting a collecting member, at a periphery of a core portion, or the like member is used. Further, as the recovering member, a recovering roller including a surface layer constituting a recovering member or the like member is used.

### SUMMARY OF THE INVENTION

According to an aspect of the present invention, there is provided an electrostatic collecting device comprising: a rotatable collecting body including a collecting member configured to form a collecting portion in contact with an object-to-be-cleaned and formed of an insulator, wherein the rotatable collecting body rubs the object-to-be-cleaned in the collecting portion with the collecting member by rotation thereof, and collects, in the collecting member, a substance-to-be-collected from the object-to-be-cleaned moved relative to the collecting portion; a removing member configured to remove the substance-to-be-collected from the collecting member; and a charge-removing member provided opposed to the object-to-be-cleaned on a side downstream of the collecting portion with respect to a movement direction of the object-to-be-cleaned relative to the collecting portion, wherein the charge-removing member constitutes at least a part of at least one of the rotatable collecting body and the removing member, and wherein the charge-removing member is electrically connected to an electric conductor which is in non-contact with the object-to-be-cleaned.

Further features of the present invention will become apparent from the following description of exemplary embodiments with reference to the attached drawings.

### BRIEF DESCRIPTION OF THE DRAWINGS

FIG. 1 is a schematic perspective view of an outer appearance of a cleaning device according to an embodiment 1.

FIG. 2 is a schematic sectional view of the cleaning device according to the embodiment 1.

Parts (a) and (b) of FIG. 3 are schematic views for illustrating a measuring method of a potential attenuation rate.

FIG. 4 is a graph for illustrating the potential attenuation rate.

FIG. 5 is a schematic side view of a part of a charge-removing member in the embodiment 1.

FIG. 6 is a schematic sectional view of a cleaning device according to a comparison example 2.

FIG. 7 is a schematic sectional view of an image forming apparatus in which a paper powder collecting device according to an embodiment 2 is mounted.

FIG. 8 is a schematic sectional view of a paper powder collecting device according to an embodiment 2.

FIG. 9 is a schematic sectional view of a paper powder collecting device according to a comparison example 4.

FIG. 10 is a schematic sectional view of a paper powder collecting device according to an embodiment 3.

### DESCRIPTION OF THE PREFERRED EMBODIMENTS

In the following, an electrostatic collecting device according to the present invention will be specifically described.

### Embodiment 1

In this embodiment, the electrostatic collecting device according to the present invention is used as a cleaning device (cleaner, manual cleaner) for cleaning a floor surface.

### (1) General Structure of Cleaning Device

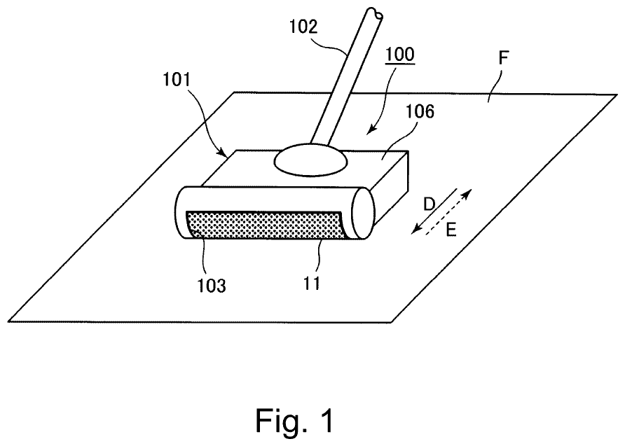

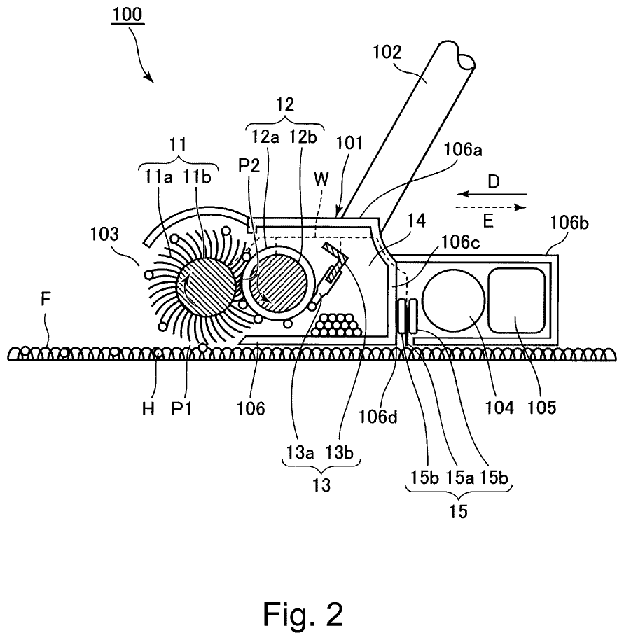

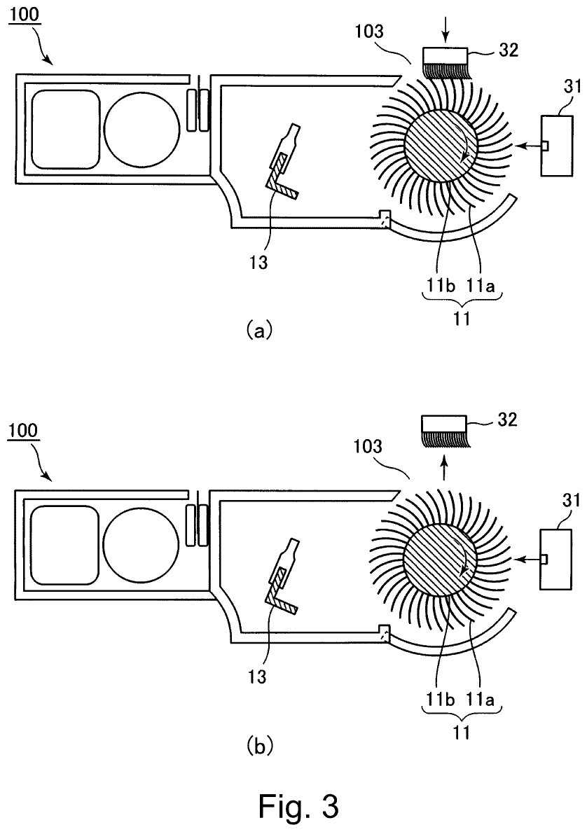

FIG. 1 is a schematic perspective view of an outer appearance of a cleaning device (cleaning apparatus) 100 of this embodiment. In this embodiment, an object-to-be-cleaned of the cleaning device 100 is principally a floor surface (particularly a carpet) F, and a substance-to-be-collected is dust (dirt) H or the like existing on the floor surface F (hereinafter, simply referred to as “dust”) (FIG. 2).

The cleaning device 100 includes an apparatus main assembly 101 and a handle 102 connected to the apparatus main assembly 101. A user holds the handle 102 and can clean the floor surface F while pushing forward the apparatus main assembly 101, placed on the floor surface F, in an arrow D direction in FIG. 1. Incidentally, the cleaning device 100 can clean the floor surface F also when pulls the apparatus main assembly 101 back in a direction opposite to the arrow D direction in FIG. 1, for example. However, in this embodiment, it is assumed that the floor surface F is cleaned while pushing forward the apparatus main assembly 101 principally in the arrow D direction in FIG. 1, a mounting position and a movable range of the handle 102 relative to the apparatus main assembly 101 are set. Here, the arrow D direction in FIG. 1 is also referred to as a “cleaning direction D”. Further, a relative movement direction of the floor surface F to the apparatus main assembly 101 in the case where the apparatus main assembly 101 moves in the cleaning direction D, i.e., an opposite direction (arrow E direction in FIG. 1) to the cleaning direction D is also referred to as a “object-to-be-cleaned movement direction E”. In a front portion of a casing 106, an opening 103 for taking the dust H inside the casing 106 is provided.

FIG. 2 is a schematic sectional view of the cleaning device 100 of this embodiment (i.e., shows a cross section substantially perpendicular to rotational axis directions of a brush roller 11 described later). The apparatus main assembly 101 of the cleaning device (cleaning apparatus) 100 includes the brush roller 11 which is a rotatable collecting body, a recovering roller 12 which is a first removing member (rotatable recovering body), a cleaning blade 13 which is a removing member (scraping-off member), an accommodating container (accommodating portion) 14, a charge-removing portion 15, a motor 104 as a driving source constituting a driving means, a battery 105 for supplying electric power to the motor 104 or the like, and the casing 106 for accommodating these parts inside thereof.

In the apparatus main assembly 101, the brush roller 11 is provided so as to be exposed to an outside of the casing 106 through the opening 103 provided in the casing 106. The brush roller 11 constitutes a collecting means for collecting the dust H deposited on the floor surface F by being rotated while rubbing the floor surface F on which the dust H is deposited. Incidentally, the floor surface F is, for example, the carpet, and the dust H enters piles of the carpet in some instances. The brush roller 11 (scrapes (takes) by rotation thereof the dust H, on the floor surface F, inside the casing 106 through the opening 103 provided in the casing 106. Further, in the apparatus main assembly 101, the recovering roller 12 and the cleaning blade 13 are provided on a side (in the rear of the brush roller 11) downstream of the brush roller 11 with respect to the object-to-be-cleaned movement direction E.

The recovering roller 12 and the cleaning blade 13 constitute a removing for removing, from the brush roller 11, the dust H deposited on the brush roller 11. Further, the accommodating container 14 is provided on a side (in the rear of the recovering roller 12 and the cleaning blade 13) downstream of the recovering roller 12 and the cleaning blade 13 with respect to the object-to-be-cleaned movement direction E. The accommodating container 14 accommodates the dust H recovered from the brush roller 11 by the recovering roller 12 and the cleaning blade 13. Further, the charge-removing portion 15 is provided on a side (in the rear of the accommodating container 14) downstream of the accommodating container 14 with respect to the object-to-be-cleaned movement direction E. The charge-removing portion 15 constitutes a charge-removing means for removing electric charges from the floor surface F electrically charged by being rubbed with the brush roller 11. Further, the motor 104 and the battery 105 for energizing the motor 104 or the like are provided on a side (in the rear of the charge-removing portion 15) downstream of the charge-removing portion 15 with respect to the object-to-be-cleaned movement direction. In this embodiment, the casing 106 is constituted by connecting a first casing 106a and a second casing 106b, and inside the first casing 106a, the brush roller 11, the recovering roller 12, the cleaning blade 13, and the accommodating container 14 are disposed. Further, the charge-removing portion 15, the motor 104, and the battery 105 are disposed inside the second casing 106b. A space inside the first casing 106a and a space inside the second casing are partitioned by a wall 106c constituting the casing 106 (at least one of the first casing 106a and the second casing 106b).

A cleaning operation by the cleaning device 100 will be briefly described. The brush roller 11 is rotated while the user pushes forward the apparatus main assembly 101 in the cleaning direction D, and thus the dust H on the floor surface F is rubbed with the brush roller 11, so that the dust H collected by the brush roller 11 is recovered, by an electrostatic depositing force, on the recovering roller 12 rotating while contacting the brush roller 11. The dust H recovered on the recovering roller 12 is scraped off from the recovering roller 12 by the cleaning blade 13, and then is accommodated in the accommodating container 14. Details of the respective members will be described below.

### (2) Brush Roller

Next, the brush roller 11 as the collecting means will be further described.

The brush roller 11 includes raisings 11a as a collecting member for rubbing the floor surface F in contact with the floor surface F, and a core portion (core metal) 11b as a supporting portion for supporting the raisings 11a. The core portion 11b of the brush roller 11 is constituted by a cylindrical member, and is disposed opposed to the floor surface F so that a rotational axis direction of the core portion 11b is substantially parallel to and crosses (typically is substantially perpendicular to) the floor surface F in a state in which the apparatus main assembly 101 is placed on the floor surface F. The core portion 11b of the brush roller 11 is supported rotatably by the casing 106 (first casing 106a) of the cleaning device 100 through a rotation shaft (not shown) provided at each of opposite end portions thereof with respect to the rotational axis direction thereof. On an outer peripheral surface of the core portion 11b of the brush roller 11, elastically deformable raisings 11a of the brush roller 11 are provided. The raisings 11a of the brush roller 11 are provided substantially uniformly on the outer peripheral surface of the core portion 11b in a substantially whole area (for example, about 200 to 300 mm) of the core portion 11b in the rotational axis direction of the core portion 116. In this embodiment, the brush roller 11 is constituted by direct planting of the raisings 11a in the outer peripheral surface of the core portion 11b. However, a planting method of the raisings 11a in the core portion 11b of the brush roller 11 is not limited particularly, but an available arbitrary method can be used. For example, the brush roller 11 may be constituted by winding a base cloth (not shown), provided with the raisings 11a, about the outer peripheral surface of the core portion 11b and by fixing the base cloth to the outer peripheral surface of the core portion 11b. As this base cloth, it is possible to use fabric formed of fibers identical to or different from the raisings 11a.

In this embodiment, the core portion 11b of the brush roller 11 is formed of aluminum which is an electroconductive metal material as an electric conductor (electroconductive material). Incidentally, in FIG. 2, component parts of the electric conductors are shown by hatched lines (the same applies to other drawings). Further, the raisings 11a of the brush roller 11 are formed of an insulating resin material as an insulator (electrically insulating material). That is, the brush roller 11 is constituted by covering the surface of the core portion 11b, formed of the electric conductor, with the raisings 11a formed of the insulator. In this embodiment, each of the raisings 11a is 11 mm in natural length (pile length), the core portion 11b of the brush roller 11 is 18 mm in outer diameter, and the brush roller 11 is 40 mm in diameter (outer diameter). Incidentally, the natural length of the raisings of the brush roller 11 is a length in the case where the raisings 11a are not deformed under application of pressure by the floor surface F and the recovering roller 12. Further, a diameter of the brush roller 11 is diameter of a circumscribed circle of the raisings 11a in a state of the natural length. A thickness of each raising 11a of the brush roller 11 may preferably be 10 denier or more from the viewpoint of a collecting performance. On the other hand, the thickness of each raising 11a of the brush roller 11 may preferably be 125 denier or less from the viewpoint such that a rotation torque of the brush roller 11 is not excessively increased. Similarly, a density of the raisings 11a of the brush roller 11 may preferably be 15 kF/inch² or more from the viewpoint of the collecting performance. On the other hand, the density of the raisings 11a of the brush roller 11 may preferably be 60 kF/inch² or less from the viewpoint such that the rotation torque of the brush roller 11 is not excessively increased. That is, the raisings of the brush roller 11 may preferably be 10 denier or more and 125 denier or less in thickness and may preferably be 15 kF/inch² or more and 60 kF/inch² or less in density.

A distance between the core portion 11b of the brush roller 11 and the floor surface F is restricted by a bottom of the casing 106, and is set to a value (for example, 10 mm) smaller than the natural length of the raisings 11a of the brush roller 11. That is, in this embodiment, a distance between a plane formed by the bottom of the casing 106 placed on the floor surface F, and the core portion 11b of the brush roller 11 is set to a value smaller than the natural length of the raisings 11a of the brush roller 11. Incidentally, the casing 106 may be provided with a member, such as wheels, placed on the floor surface F. In this case, a distance between a contact portion of the wheels or the like with the floor surface F, and the core portion 11b of the brush roller 11 may only be required to be set to a value smaller than the natural length of the raisings 11a of the brush roller 11. Accordingly, the brush roller 11 rotates while the raisings 11a thereof contact the floor surface F. To the brush roller 11, a driving force from the motor 104 is transmitted by a drive transmitting member (not shown), so that the brush roller 11 is rotated in an arrow direction (clockwise direction) in FIG. 2 at a peripheral speed (surface movement speed) of 140 mm/sec. That is, the brush roller 11 is rotated so that the movement direction of the raisings 11a and the object-to-be-cleaned movement direction E become opposite directions in a contact portion (collecting portion) P1 between the raisings 11a and the floor surface F. By the rotation of the brush roller 11, the raisings 11a of the brush roller 11 are circumferentially moved. The brush roller 11 collects the dust H from on the floor surface F by rubbing the floor surface F and the dust H on the floor surface F with the raisings 11a contacting the floor surface F so as to stroke the floor surface F while being rotated.

Incidentally, the rotational direction and the peripheral speed of the brush roller 11 are not limited to those in this embodiment. The brush roller 11 may be rotated so that the movement direction of the raisings 11a and the object-to-be-cleaned movement direction E become the same (forward) direction in the contact portion (collecting portion) P1 between the raisings 11a and the floor surface F. Further, the peripheral speed of the brush roller 11 may be made faster or slower than that in this embodiment.

Here, the insulator refers to a substance of 10⁸ (Ω·m) or more, preferably 10¹⁰ (Ω·m) or more in volume resistivity. However, typically, the insulator is 10¹⁶ (Ω·m) or less in volume resistivity. Further, the electric conductor (electroconductor) refers to a substance of 10⁻⁶ (Ω·m) or less, typically about 10⁻⁸ (Ω·m) in volume resistivity. Further, a semiconductor refers to a substance of which volume resistivity is volume resistivity between those of the insulator and the electric conductor.

Further, for convenience, a magnitude (high/low) of a distance (or a potential difference) refers to a magnitude (high/low) in the case where values thereof are compared with each other in terms of an absolute value, unless otherwise specified.

When substances different in position of a triboelectric charge series are rubbed with each other, electric charges are exchanged to each other between these substances, so that one is electrically charged to a positive polarity, and the other is electrically charged to a negative polarity. A series of permutations of these positive and negative polarities is the triboelectric charge series, and in general, there is a tendency that substances are strongly charged with a remoter positional relationship in the triboelectric charge series. Further, in general, in many cases, the dust H includes dust, on the side positive in position in the triboelectric charge series, such as various fibers inclusive of cotton dust generated from clothes or the like, human dandruff and sebum, dung and cadavers of mites, and the like. Incidentally, the same applies to photosensitive drum described later in embodiments 2 and 3. As the material of the raisings 11a of the brush roller 11, it is desirable that a material of which position in the triboelectric charge series in remote from the dust H on the negative side to the extent possible and is on the positive side relative to the material (PFA in this embodiment) of the surface layer 12a of the recovering roller 12 described later. For that reason, in this embodiment, the raisings 11a of the brush roller 11 are formed of PET (polyethylene terephthalate) fibers which are fibers constituted by the PET. When the raisings 11a of the rotating brush roller 11 and the dust H on the floor surface F are rubbed with each other, the raisings 11a of the brush roller 11 are negatively charged, and the dust H is positively charged. As a result, the raisings 11a of the brush roller 11 become high in potential on the positive side compared with the floor surface F, so that the dust H can be collected from on the floor surface F. In this embodiment, the material of the raisings 11a of the brush roller 11 is 10¹³ Ω·cm and 10¹⁸ Ω·cm or less in volume resistivity.

The raisings 11a perform a function of collecting the dust H as described above, so that the raisings 11a of the brush roller 11 may preferably be 10% or less in attenuation rate (factor) of a surface potential during rotation of the brush roller 11 through one full circumference (herein, this attenuation rate is also referred to as a “potential attenuation rate R₁”). The potential attenuation rate may be 0%.

When the raising rate R₁ is larger than 10%, it becomes difficult that the dust H collected in the raisings 11a is held during rotation of the brush roller 11, so that the dust H is scattered to a periphery of the brush roller 11 in some cases. In the following, a measuring method of the potential attenuation rate R₁ and potential attenuation time constant will be described.

Parts (a) and (b) of FIG. 3 are schematic views for illustrating the measuring method of the potential attenuation rate R₁ and the potential attenuation time constant. First, as shown in part (a) of FIG. 3, the cleaning device 100 is placed so that the opening 103 thereof is directed upward in a state in which the recovering roller 12 is demounted therefrom. The brush roller 11 is rotated at a peripheral speed of 140 mm/sec in an arrow direction (clockwise direction) in part (a) of FIG. 3, and a potential of surfaces of the raisings of the brush roller 11 (outer peripheral surface of the brush roller 11) is measured by a surface electrometer (tradename: “MODEL P0865”, manufactured by Trek Japan K.K.). Against the raisings 11a of the brush roller 11, a rubbing member 32 is pressed for 5 seconds in an arrow direction (direction from above (upper side) toward below (lower side), in part (a) of FIG. 3 with a pressure of 0.01 g/cm².

The rubbing member 32 may preferably be a brush-shaped member which is formed of a material of which position in the triboelectric charge series is remote from the PET as can as possible on the negative side and which is high in contact rate to the raisings 11a. In this embodiment, a brush (pile length: 6 mm, thickness: 3 denier, density: 15-60 kF/inch² provided with raisings of nylon N6 which is an insulating resin material was used. After the rubbing member 32 is pressed against the raisings 11a of the brush roller 11, as shown in part (b) of FIG. 3, the rubbing member 32 is separated in an arrow direction (direction from below toward above) in part (b) of FIG. 3, and then a surface potential of the raisings 11a of the brush roller 11 was measured with time (time transition).

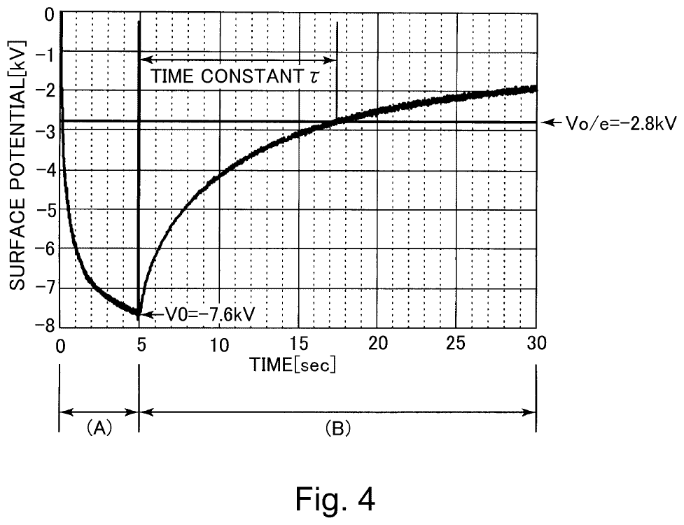

FIG. 4 shows the time transition of the surface potential of the raisings 11a of the brush roller 11. In first 5 seconds (region (time zone) of (A) in FIG. 4), the rubbing member 32 is pressed against the raisings 11a of the brush roller 11, and therefore, the surface potential (initial potential) of the raisings 11a was increased up to V₀=−7.6 kV. When the rubbing member 32 is separated (retracted) from the raisings 11a of the brush roller 11, the surface potential of the raisings 11a starts to decrease. From a decreasing curve of the surface potential of the raisings 11a, a potential attenuation time constant t is acquired. The potential attenuation time constant t is defined as a time required that the surface potential (residual potential) is attenuated to V₀×(1/e) and becomes an index of ease of retention of the charged potential. Here, e is the base of a natural logarithm. When the surface potential of the raisings 11a of the brush roller 11 is attenuated from V₀ at the time when the rubbing member 32 is separated (retracted) from the raisings 11a (region (time zone) of (B) in FIG. 4), a time required for the surface potential to be attenuated to V₀×(1/e)=−2.8 KV was 12.5 sec., so that the potential attenuation time constant τ is 12.5 sec. A surface potential VB of the raisings 11a of the brush roller 11 in the region of (B) in FIG. 4 (herein, this region is also referred to as a “potential attenuation period” can be approximated by the following formula (1).

$${V}_{B} ( t ) - {V}_{0} \times exp ( - t / τ ) \qquad ( 1 )$$

In the formula (1), t is an elapsed time (sec), V₀ is the initial potential (potential at t=5 sec) (V), and t is the potential attenuation time constant (sec).

Further, the potential attenuation rate R₁ after rotation of the brush roller 11 through one-full circumference is represented by the following formula (2).

$$\begin{matrix}{R}_{1} = 1 - {V}_{B} ( {t}_{1} ) / {V}_{0} = 1 - exp ( - {t}_{1} / τ ) \\ {t}_{1} = π d / s\end{matrix} \qquad ( 2 )$$

In the formula (2), t₁ is a time (sec), required that the brush roller 11 is rotated through one-full circumference, π is circular constant (circumference ratio), d is a diameter (mm) of the brush roller 11, s is a peripheral speed (surface movement speed) (mm/sec) of the brush roller 11, and τ is the potential attenuation time constant (sec).

As described above, the potential attenuation ratio R₁ may preferably be 10% or less. In the constitution of this embodiment, the brush roller 11 is 40 mm in diameter and 140 mm/sec in peripheral speed, so that the time t₁ required that the brush roller 11 is rotated through one-full circumference is 0.90 sec. In the case where the raisings 11a with the potential attenuation time constant t=12.5 sec is used, from the formula (1), after t₁=0.90 sec, the potential attenuation rate R₁ becomes 6.9%. Thus, the brush roller 11 in this embodiment is 10% or less in potential attenuation rate R₁. In a table 1, a measurement result and calculation result of values relating to the potential attenuation rate R₁ and the potential attenuation time constant τ are summarized.

TABLE 1

| | | |
|---|---|---|
| Time constant | 12.5 | sec |
| Brush roller diameter | 40 | mm |
| Surface speed | 140 | mm/sec |
| OFCT*¹ | 0.90 | sec |
| PAOFC*² | −7.1 | kV |

| | |
|---|---|
| Potential attenuation | 6.9% |

*¹“OFCT” is a one-full circumference time.
*²“PAOFC” is a potential after (rotation through) one-full circumference.

### (3) Removing Means

Next, the recovering roller 12 and the cleaning blade 13 which are as a removing means will be described.

The recovering roller 12 which is a first removing member (rotatable recovering body) includes a surface layer 12a as a recovering member for recovering the dust H from the raisings 11a of the brush roller 11 and a base portion (core metal) 12b on which the surface layer 12a is provided at an outer periphery of the base portion 12b. The base portion 12b of the recovering roller 12 is constituted by a cylindrical member and is disposed opposed to the brush roller 11 so that a rotational axis direction thereof and the rotational axis direction of the brush roller 11 are substantially parallel to each other. The recovering roller 12 is rotatably supported by the casing 106 (first casing 106a) through a rotation shaft portion (not shown) provided at each of opposite end portions with respect to the rotational axis direction thereof. A length of the recovering roller 12 in the rotational axis direction is equal to a length of a range (region), in which the raisings 11a are provided, of the brush roller 11 in the rotational axis direction. In this embodiment, the base portion 12b of the recovering roller 12 is formed of aluminum which is an electroconductive metal material as an electric conductor. Further, the surface layer 12a of the recovering roller 12 is formed of an insulating region material as an insulator. That is, the recovering roller 12 is constituted by coating the surface of the base portion 12b formed of the electric conductor with the surface layer 12a formed of the insulator. In this embodiment, the recovering roller 12 is 0.5 mm in thickness of the surface layer 12a, 24 mm in diameter of the base portion 12b, and 25 mm in outer diameter thereof. A distance between the core portion 11b of the brush roller 11 and the recovering roller 12 is set to a value (for example, 7 mm) smaller than the natural length of the raisings 11a of the brush roller 11. Accordingly, the recovering roller 12 rotates while contacting the raisings 11a of the brush roller 11. That is, the brush roller 11 rotates while being deformed at the raisings 11a thereof by the floor surface F and the recovering roller 12. The recovering roller 12 is rotated in an arrow direction (counterclockwise direction) in FIG. 2 at a peripheral speed (surface movement speed) of 140 mm/sec by transmission thereto a driving force from the motor 104. That is, the recovering roller 12 is rotated so that in a contact portion (recovering portion) P2 between the raisings 11a of the brush roller 11 and the recovering roller 12, a movement direction of the raisings 11a of the brush roller 11 and a surface movement direction of the recovering roller 12 are the same direction (forward direction). The recovering roller 12 is rotated, whereby the surface layer 12a of the recovering roller 12 is circumferentially moved.

Incidentally, the rotational direction and the peripheral speed of the recovering roller 12 are not limited to those in this embodiment. The recovering roller 12 may be rotated so that in the contact portion (recovering portion) P2 between the raisings 11a of the brush roller 11 and the recovering roller 12, the movement direction of the raisings 11a of the brush roller 11 and the surface movement direction of the recovering roller 12 are opposite directions to each other. Further, the peripheral speed of the recovering roller 12 may be made fastener or slower than that in this embodiment.

As a material of the surface layer 12a of the recovering roller 12, a material of which position in the triboelectric charge series is on a side further negative than the material (PET in this embodiment) of the raisings 11a of the brush roller 11 with respect to the dust H. In this embodiment, the surface layer 12a of the recovering roller 12 is formed of PFA (tetrafluoroethylene-perfluoroalkylvinyl either copolymer) which is a kind of fluorine-containing resin. For that reason, the surface layer 12a of the recovering roller 12 is charged to an opposite polarity (negative) to the polarity of the dust H by friction with the raisings 11a of the brush roller 11 and the dust H. At this time, the surface layer 12a of the recovering roller 12 is charged so that a charge amount per unit area thereof is larger than that of the raisings 11a of the brush roller 11. As a result, the surface layer 12a of the recovering roller 12 can attract the dust H from the surface of the raisings 11a of the brush roller 11. The dust H attracted to the surface layer 12a of the recovering roller 12 is scraped off by the cleaning blade 13 and is accommodated in the accommodating container 14 provided in the casing 106 (first casing 106a).

In this embodiment, the cleaning blade 13 which is the second removing member (scraping-off member) is constituted by including a cleaning blade supporting portion (supporting metal plate) 13b and a cleaning blade rubber portion 13a. The cleaning blade supporting portion 13b is formed of a plated steel plate which is an electroconductive metal material as an electric conductor. The cleaning blade rubber portion 13a is formed of polyurethane (urethane rubber) which is a rubber material as an elastic member (elastic material) having appropriate elasticity and hardness. The cleaning blade 13 is mounted to the casing 106 (first casing 106a) by fixing the cleaning blade rubber portion 13a to the cleaning blade supporting portion 13b and by fixing the cleaning blade supporting portion 13b to the casing 106. The cleaning blade rubber portion 13a is a rectangular plate-like member in plan view which has a predetermined length and a predetermined thickness with respect to a longitudinal direction disposed substantially parallel to the rotational axis direction of the recovering roller 12 and a widthwise (short side) direction perpendicular to the longitudinal direction, respectively. The length of the cleaning blade rubber portion 13a in the longitudinal direction is equal to the length of the recovering roller 12 in the longitudinal direction. The cleaning blade rubber portion 13a is contacted to the surface of the recovering roller 12 at a free end portion thereof so that the free end portion which is one end portion with respect to the widthwise direction is positioned upstream of a fixed end portion which is the other end portion with respect to the surface movement direction of the recovering roller 12. That is, the cleaning blade 13 is contacted to the surface of the recovering roller 12 in a counterdirection to the rotational direction of the recovering roller 12. The dust H scraped off from the surface of the rotating recovering roller 12 is accommodated in the accommodating container 14 provided in the casing 106 (first casing 106a).

In the above-described manner, the dust H is removed from the brush roller 11 by the recovering roller 12 and the cleaning blade 13 which constitute the removing means.

Incidentally, the removing member for removing the dust H from the recovering roller 12 is not limited to the blade-like member, but may also be, for example, a pad-like member, a sheet-like member, a brush-like member, and the like.

### (4) Charge-Removing Means

Next, the charge-removing portion 15 as a charge-removing means will be further described. The charge-removing portion 15 is provided in a position on a side downstream of the brush roller 11 (and further the recovering roller 12, the cleaning blade 13, and the accommodating container 14 in this embodiment) with respect to a measuring object movement direction E. That is, the charge-removing portion 15 is disposed in the position on the side downstream of the collecting portion P1 with respect to the measuring object movement direction E. The charge-removing portion 15 is mounted to the casing 106 (second casing 106b) so that a charge-removing cloth 15a described later is exposed to an outside of the casing 106 (second casing 106b) through a charge-removing opening 106d provided in a bottom of the casing 106 (second casing 106b) and opposes the floor surface F.

The charge-removing portion 15 is constituted by including the charge-removing cloth 15a as the charge-removing member and a charge-removing cloth supporting portion 15b for supporting the charge-removing cloth 15a. The charge-removing cloth 15a is supported by being nipped by the charge-removing cloth supporting portion 15b and is fixed to the casing 106 (second casing 106b) by fixing the charge-removing cloth supporting portion 15b to the casing 106 (second casing 106b). The charge-removing cloth supporting portion 15b is formed of ABS (acrylonitrile-butadiene-styrene) resin which is the insulating resin material as the insulator. The charge-removing member is formed of an electric conductor or a semiconductor.

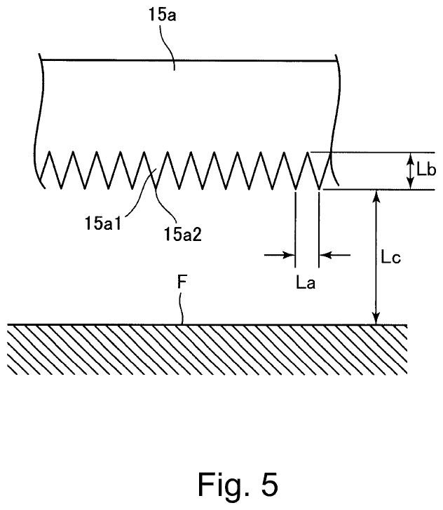

In this embodiment, the charge-removing cloth 15a as the charge-removing member is formed of nonwoven fabric sheet constituted by electroconductive or semiconductive fibers. Particularly, in this embodiment, the charge-removing cloth 15a is formed of a 0.1 mm-thick sheet constituted by an aggregate (nonwoven fabric) which is fibers constituted by using metal yarns and which is prepared by assembling fine composite fibers of acrylonitrile-copper sulfide into a felt form. FIG. 5 is a schematic side view in which a part of the charge-removing cloth 15a is viewed along the cleaning direction D (or the object-to-be-cleaned movement direction E). The charge-removing cloth 15a is disposed along a direction crossing (typically, perpendicular to) the cleaning direction D (or the object-to-be-cleaned movement direction E), i.e., a direction substantially parallel to the rotational axis direction of the brush roller 11. In this embodiment, a length of the charge-removing cloth 15a in the longitudinal direction is equal to the length of the brush roller 11 in the longitudinal direction. Incidentally, the length of the charge-removing cloth 15a in the longitudinal direction may preferably be longer than a length of a region in which the raisings 11a of the brush roller 11 are provided (and further, the length of the surface layer 12a of the recovering roller 12) in the longitudinal direction. That is, in the longitudinal direction of the charge-removing cloth 15a, the region in which the raisings 11a of the brush roller 11 are provided (and further, the surface layer 12a of the recovering roller 12) may preferably fall inside the charge-removing cloth 15a. By this, the floor surface F charged by the brush roller 11 can be charge-removed effectively. Each of the fibers constituting the charge-removing cloth 15a in this embodiment is 15.6 to 19 μm in diameter, i.e., very fine, and is about 5.85×10⁻² Ω·cm in volume resistivity, so that the fibers are a semiconductor close to a conductor. For that reason, the fibers have an excellent corona discharging property. When a strong electric field is induced in the acrylonitrile-copper sulfide composite fibers, ambient air of the fibers is ionized, so that polar transport of the acrylonitrile-copper sulfide composite fibers occurs. By this phenomenon, accumulated negative electric charges are dissipated from a free end portion into the air. This ionization of the air is liable to occur at the free end portion of cut fibers. For that reason, in this embodiment, a shape of the free end portion of the charge-removing cloth 15a opposing the floor surface F is a sawtooth shape as shown in FIG. 5. By this, many free end portions of the cut fibers face in a direction of the floor surface F. Further, the acrylonitrile-copper sulfide composite fibers are high in electric resistance compared with metal, and therefore, even if the user touches the fibers, abrupt electric discharge does not readily occur. Further, the fibers of the charge-removing cloth 15a are soft, and therefore, compared with a charge-removing needle or wire made of metal, even if the fibers touch an object such as the floor surface F, a possibility that the fibers damage the floor surface F or the like is low.

In this embodiment, a pitch La of a mountains 15al of the free end portion of the charge-removing cloth 15a opposing the floor surface F is set to 1 mm, and a height Lb of the mountains 15al is set to 2 mm. Further, a top 15a2 of the mountain 15al of the charge-removing cloth 15a is set so that a distance Lc thereof from the floor surface F in a vertical direction becomes 6.0 mm. That is, in this embodiment, a distance between a surface formed by the bottom of the casing 106 placed on the floor surface F and the top 15a2 of the mountain 15a1 of the charge-removing cloth 15a is set to the above-described distance Lc. Incidentally, in the case where the casing 106 is provided with wheels or the like placed on the floor surface F, a distance between a surface formed by a contact portion of the wheels with the floor surface F, and the top 15a2 may only be required to be set to the distance Lc. The distance La may preferably be about 2 mm or more from a viewpoint such that electric field concentration is appropriately caused to occur in order to stably cause the corona discharge. On the other hand, the distance La may preferably be about 15 mm or less from a viewpoint such that a shape in which the corona discharge is generated at many points as can as possible is formed. Further, similarly as the distance La, the distance Lb may preferably be about 2 mm or more from the viewpoint such that the electric field concentration is appropriately caused to occur in order to stably cause the corona discharge. On the other hand, similarly as the distance L1, the distance Lb may preferably be about 15 mm or less from the viewpoint such that the shape in which the corona discharge is generated at many points as can as possible is formed. Further, from the viewpoint such that the electric field concentration is appropriately caused to occur in order to stably cause the corona discharge, in the case where the metal charge-removing needle or wire is used as the charge-removing member (see embodiments 2 and 3), the distance Lc may preferably be about 2 mm or more. When the distance Lc is smaller than this value, there is a possibility that the electric discharge concentrates at one point and thus a large current flows.

In this case, the charge-removing member is provided in non-contact with and so as to oppose the object-to-be-cleaned. Further, in the case where a member formed of a material, relatively high in electric resistance, such as the acrylonitrile-copper sulfide composite fibers is used as the charge-removing member (this embodiment), a risk that a large current flows is low, so that the charge-removing member may contact the object-to-be-cleaned. In this case, the charge-removing member is provided in non-contact or contact with the object-to-be-cleaned and so as to oppose the object-to-be-cleaned. On the other hand, in the case where the metal charge-removing needle or wire is used as the charge-removing member (see embodiments 2 and 3), the distance Lc may preferably be 20 mm or less from the viewpoint such that the electric field concentration is appropriately caused to occur in order to stably cause the corona discharge. Further, in the case where a member formed of a material, capable of causing the polar transport, such as the acrylonitrile-copper sulfide composite fibers is used as the charge-removing member, ion can be dissipated from the free end portion of the charge-removing member (fibers) into the air. For that reason, in this case, the distance Lc can be increased than in the case where the above-described metal charge-removing needle or wire is used, and the distance Lc may preferably be 200 mm or less.

In this embodiment, the charge-removing cloth 15a is electrically connected by wiring W to electric conductor portions so as to have the same potential to those of the core portion 11b of the brush roller 11, the base portion 12b of the recovering roller 12, and the cleaning blade supporting portion 13b which are formed of the electric conductors. As described above, when two substances remote in positional relationship of the triboelectric charge series from each other are rubbed with each other, these two substances are gradually charged. When cleaning of the floor surface F is continued while moving the apparatus main assembly 101, electric charges are gradually accumulated continuously in the raisings 11a of the brush roller 11 and the surface layer 12a of the recovering roller 12. The accumulated electric charge are moved to the above-described electric conductor portions through phenomena such as dielectric polarization and minute electric discharge, so that potentials of the electric conductor portions are increased in a negative direction. Here, the electric conductor portions are connected to the charge-removing cloth 15a by the wiring W, so that a potential difference between the charge-removing cloth 15a and the floor surface F is increased and generation of the electric discharge from the charge-removing cloth 15a is promoted, and thus an effect of lowering the positive potential of the floor surface F is increased.

Further, the charge-removing cloth 15a is connected to the electric conductor portions by the wiring W, so that it is possible to suppress that the potentials of the above-described electric conductor portions are excessively increased. For that reason, it is possible to suppress occurrence of abrupt electric discharge from the cleaning device 100 to the floor surface F and occurrence of discomfort spark discharge from the cleaning device 100 to the user. From such a viewpoint, it is desirable that the charge-removing portion 15 is disposed in a position remote from the handle 102, which is touched by the user, to the extent possible, and further is disposed in a position where the user does not readily touch the charge-removing portion 15. In this embodiment, the handle is mounted to an upper portion of the casing 106, whereas the charge-removing portion 15 is provided adjacent to the charge-removing opening 106d provided at a lower portion of the casing 106, so that the charge-removing portion 15 is remote from the handle 102. Further, in this embodiment, the charge-removing portion 15 is provided adjacent to the charge-removing opening 106d, which opens downward, between the first casing 106a and the second casing 106B constituting the casing 106 (at a substantially central portion of the casing 106 with respect to the cleaning direction D), so that a possibility that the user unintentionally touches the charge-removing portion 15 is low.

In this embodiment, the casing 106 (the first casing 106a and the second casing 106b) is formed of ABS resin. Further, the wall 106c of the casing 106 is interposed as a shielding portion between the charge-removing portion 15 and the brush roller 11 or the recovering roller 12, and prevents movement of the ionized air. That is, by the wall 106c of the casing 106, the air containing the negative ion generated by the charge-removing cloth 15a of the charge-removing portion 15 is prevented from reaching the brush roller 11 and the recovering roller 12. A material of this shielding portion may be an insulator or an electric conductor. In this embodiment, as described above, the wall 106c of the casing 106 as the shielding portion is formed of the ABS resin which is an insulating resin material. By such a constitution, the surface potentials of the brush roller 11 and the recovering roller 12 lower, so that a lowering in cleaning function can be suppressed.

Incidentally, in the case of a constitution in which the shielding portion such as the wall 106c of the casing 106 is not interposed between the brush roller 11 or the recovering roller 12 and the charge-removing portion 15, the following constitution may desirably be employed. That is, it is desirable that the charge-removing portion 15 (particularly, the charge-removing cloth 15a) is provided by being separated from the brush roller 11 or the recovering roller 12 (charging object) by at least 30 mm. That is, it is desirable that a closest distance between the charge-removing portion 15 (particularly, the charge-removing cloth 15a) and the brush roller 11 or the recovering roller 12 is made 30 mm or more. By this, a lowering in potential of the brush roller 11 or the recovering roller 12 by the air ionized by the charge-removing portion 15 can be suppressed.

### (5) Evaluation Experiment

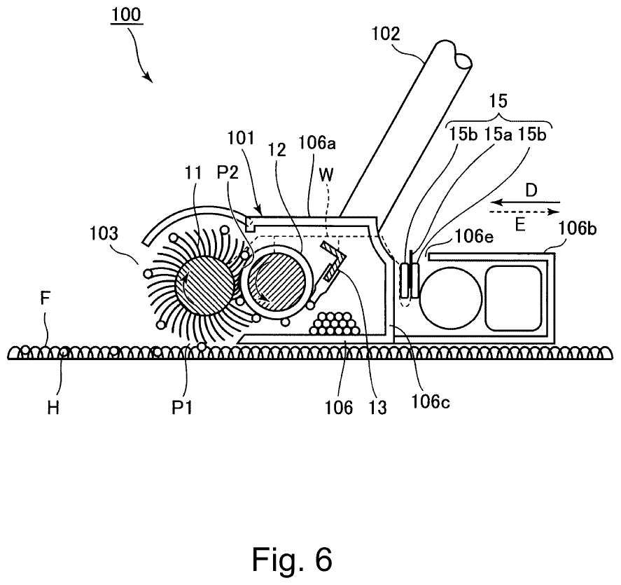

In order to verify an effect of this embodiment, comparison verification is conducted between the constitution of this embodiment and a constitution of each of a comparison example 1 and a comparison example 2. The constitution of the comparison example 1 is a constitution in which the charge-removing portion 15 in the constitution of this embodiment is not provided. The constitution of the comparison example 2 is a constitution in which as shown in FIG. 6, the charge-removing portion 15 having the same constitution similar to the constitution of this embodiment is not provided on the floor surface F but is provided toward an upper space of the apparatus main assembly 101.

In the constitution of the comparison example 2, a charge-removing opening 106e is provided on a top side of the casing 106 (second casing 106b) in a position opposing the charge-removing opening 106d in this embodiment. Further, the charge-removing portion 15 is provided so that the charge-removing cloth 15a is exposed to an outside of the casing 106 (second casing 106b) through this charge-removing opening 106e. The constitutions of the comparison example 1 and the comparison example 2 are substantially the same as the constitution of this embodiment except for the above-described points. Also, as regards the comparison example 1 and the comparison example 2, elements having functions or constitutions, which are identical to or corresponding to those of this embodiment will be described by adding thereto the same reference numerals or symbols.

An experiment was conducted in the following manner. As the floor surface F which is an object-to-be-cleaned, a floor surface F constituted by a plate material (thickness: 2 mm) made of polycarbonate which is an insulator, placed on aluminum connected to ground potential (GND) (electrically grounded) was used. In a region of 500 mm×50 mm on the floor surface F, a cleaning operation such that an operation in which the apparatus main assembly 101 is placed on the floor surface F and is moved in the cleaning direction D by 200 mm, and then is one raised and returned to an original position and is placed again on the floor surface F, followed by movement in the cleaning direction D is repeated, was performed. Then, a potential of the electric conductor portion (the core portion 11b of the brush roller 11, the base portion 12b of the recovering roller 12, the cleaning blade supporting portion 13b) and a potential of the floor surface F after the cleaning operation were measured. A result thereof is shown in a table 2 below.

Incidentally, when the potential of the above-described electric conductor portion is up to about −1000 V, even if electric discharge occurs from the cleaning device 100 to the user, the user does not notice the occurrence of the electric discharge in many cases. Further, when the potential of the above-described electric conductor portion becomes −3000 or more (absolute value), electric discharge to the extent that the user notifies it in some instances, and particularly when the potential of the electric conductor portion becomes −5000 V or more, spark discharge discomfort to the user occurs in some instances.

TABLE 2

| | | |
|---|---|---|
| COMP. | COMP. | |
| EX. 1 | EX. 2 | EMB. 1 |

| | | | | | | |
|---|---|---|---|---|---|---|
| EPP*¹ | −4500 | V | −3000 | V | −200 | V |
| FSP*² | 2500 | V | 1000 | V | 100 | V |

*¹“EPP” is the electric conductor portion potential.
*²“FSP” is the floor surface potential after passing of the apparatus main assembly 101.

In the constitution of the comparison example 1, when the cleaning operation was continued for 1 to 2 minutes, the potential of the electric conductor portion was increased to −4500 V, and the potential of the floor surface F after passing of the apparatus main assembly 101 was increased to +2500 V.

In the constitution of the comparison example 2, when the cleaning operation was continued for 1 to 2 minutes, the potential of the electric conductor portion was increased to −3000 V, and the potential of the floor surface F after passing of the apparatus main assembly 101 was increased to +1000 V. This would be considered for the following reason. In the constitution of the comparison example 2, the sawtooth-shaped portion of the charge-removing cloth 15a is disposed upward, and therefore, the negative ion generated in the neighborhood of the free end portion of the charge-removing cloth 15a stagnates in the place and a concentration thereof gradually becomes high, so that an ionization speed gradually becomes slow. For that reason, although the potential of the electric conductor portion is lower than that in the comparison example 1, the potential of the electric conductor portion become relatively high, and the potential of the floor surface F also became relatively high.

On the other hand, in this embodiment, the potential of the electric conductor portion after the cleaning operation was continued for 1 to 2 minutes, was decreased to −200 V, and the potential of the floor surface F after passing of the apparatus main assembly 101 was decreased to +100 V. This would be considered because an efficient cycle such that a degree of negative charging of the cleaning device 100 itself is reduced and the positively charged floor surface F is charge-removed.

Thus, in this embodiment, the charge-removing cloth 15a of the charge-removing portion 15 and the above-described electric conductor portions are connected by the wiring W, so that a charge-removing effect of the floor surface F by the charge-removing portion 15 is increased and thus the floor surface F can be charge-removed to a lower potential. Further, in this embodiment, the negative electric charge accumulated in the cleaning device 100 can also be effectively dissipated.

Incidentally, in this embodiment, the charge-removing member (charge-removing cloth) 15a is electrically connected to the core portion 11b of the brush roller 11, the base portion 12b of the recovering roller 12, and the cleaning blade supporting portion 13b, but the present invention is not limited thereto. The charge-removing member (charge-removing cloth) 15a may only be required to be electrically connected to at least one of these portions.

Further, the resin material constituting the collecting member such as the raisings of the brush roller is not limited to the PET, but may also be, for example, another polyester resin, urethane resin, acrylic resin, polyethylene resin, polypropylene resin, and the like. Further, the resin material constituting the recovering member such as the surface layer of the recovering roller may preferably be fluorine-containing resin from a viewpoint of efficiently collecting a substance-to-be-collected, but the present invention is not limited thereto. For example, the resin material may also be silicone resin. Further, the fluorine-containing resin is not limited to the PFA, but may also be, for example, PTFE (polytetrafluoroethylene), FEP (tetrafluoroethylene-hexafluoropropylene copolymer), ETFE (tetrafluoroethylene-ethylene copolymer), PVDF (polyvinylidene difluoride), PCTFE (polychlorotrifluoroethylene), ECTFE (ethylene/chlorotrifluoroethylene copolymer), and the like.

Thus, the electrostatic collecting device (cleaning device) 100 of this embodiment includes a rotatable collecting body 11 which is a rotatable collecting body (brush roller) 11 which is provided with a collecting member (raising) 11a forming a collecting portion P1 in contact with an object-to-be-cleaned (floor surface) F and formed of an insulator, and which rubs the object-to-be-cleaned F in the cleaning portion P1 with the collecting member 11a by rotation thereof, and collects, in the collecting member 11a, a substance-to-be-collected (dust) H from the object-to-be-cleaned F moved relative to the collecting portion P1; and a removing member (recovering roller 12, cleaning blade 13) for removing the substance-to-be-collected H from the collecting member 11a. Further, this electrostatic collecting device 100 includes a charge-removing member (charge-removing cloth) 15a provided opposed to the object-to-be-cleaned F on a side downstream of the collecting portion P1 with respect to a movement direction E of the object-to-be-cleaned F relative to the collecting portion P1, wherein the charge-removing member 15a constitutes at least a part of at least one of the rotatable collecting body 11 and the removing members 12 and 13, and the charge-removing member 15a is electrically connected to an electric conductor (core portion 11a, base portion 12b, cleaning blade supporting portion 13b) which is in non-contact with the object-to-be-cleaned F.

In this embodiment, the rotatable collecting body 11 is constituted by a brush roller provided with a core portion 116 and a plurality of raisings 11a provided on an outer periphery of the core portion 11b and constituting the collecting member. Further, in this embodiment, the charge-removing member 15a is electrically connected to an electric conductor constituting the core portion 11b. Further, in this embodiment, the charge-removing member includes a first removing member (recovering roller) 12 for recovering the substance-to-be-collected from the collecting member 11a, and a second removing member (cleaning blade) 13 for removing the substance-to-be-collected H, recovered from the collecting member 11a in the first removing member 12, from the first removing member 12. Further, in this embodiment, the charge-removing member 15a is electrically connected to an electric conductor constituting at least a part of at least one of the first removing member 12 and the second removing member 13.

Further, in this embodiment, the charge-removing member 15a is constituted by using metal threads (yarns). Particularly, in this embodiment, the charge-removing member 15a is constituted by using acrylonitrile-copper sulfide composite fibers. Further, in this embodiment, an end portion of the charge-removing member 15a opposing the object-to-be-cleaned F is formed in a saw-tooth shape. Further, in this embodiment, the electrostatic collecting device 100 includes a shielding portion (casing wall 106c) for shielding the rotatable collecting body 11 from the charge-removing member 15a. Further, the charge-removing member 15a may be disposed in a position apart from the rotatable collecting body 11 by at least 30 mm. Further, a length of the charge-removing member 15a in a longitudinal direction is longer than a length of a region, in which the collecting member 11a is provided, in a direction substantially perpendicular to a circumferential movement direction of the collecting member 11a by rotation of the rotatable collecting body 11. Further, a potential attenuation rate R₁ of a surface of the collecting member, after rotation through one full circumference, represented by the following formula (1) may preferably be 10% or less:

R₁=1−exp(−t₁/τ) (1)

[in this formula, t₁ is a time required for the rotation of the collecting member through one full circumference, τ is potential attenuation time constant and is a time required for attenuating a surface potential of the collecting member to V₀×(1/e) when the surface of the collecting member is electrically charged to the initial potential V₀ (e is base of natural logarithm)]. Further, in this embodiment, the electrostatic collecting device 100 collects dust H as the substance-to-be-collected from the object-to-be-cleaned (floor surface) F.

As described above, according to this embodiment, in the cleaning device 100, the floor surface F charged by being rubbed with the raisings 11a of the brush roller 11 can be charge-removed efficiently. By this, re-deposition or the like of the dust H onto the floor surface F can be suppressed. Further, according to this embodiment, it is possible to suppress that the electric charge is excessively accumulated in the cleaning device 100. By this, it is possible to suppress abrupt electric discharge from the cleaning device 100 to the object-to-be-cleaned or the user.

### Embodiment 2

Next, another embodiment of the present invention will be described. In this embodiment, an application purpose of an electrostatic collecting device according to the present invention is different from that of the embodiment 1. In this embodiment, the electrostatic collecting device according to the present invention is used as a paper powder collecting device for collecting paper powder as a substance-to-be-collected from a recording material as an object-to-be-cleaned in an image forming apparatus.

### (1) Image Forming Apparatus

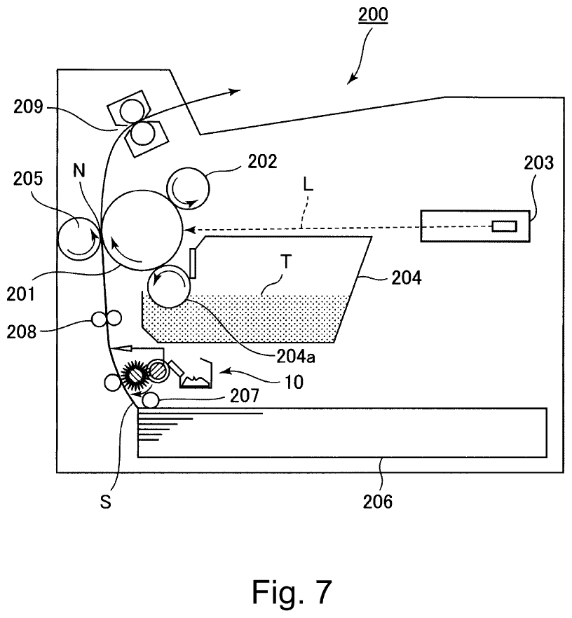

FIG. 7 is a schematic sectional view of an image forming apparatus 200 in which the electrostatic collecting device of this embodiment is used as the paper powder collecting device. In this embodiment, the image forming apparatus 200 is a monochromatic laser beam printer capable of forming a black (monochromatic) image by using an electrophotographic type.

The image forming apparatus 200 includes a photosensitive drum 201 which is a rotatable drum-type (cylindrical) photosensitive member (electrophotographic photosensitive member) as an image bearing member. When an image outputting operation is started, the photosensitive drum 201 is rotationally driven in an arrow direction (clockwise direction) in FIG. 7. In this embodiment, an outer diameter of the photosensitive drum 201 is 30 mm, and a peripheral speed (surface movement speed) of the photosensitive drum 201 is 140 mm/sec.

A surface of the rotating photosensitive drum 201 is electrically charged uniformly to a predetermined polarity (negative polarity in this embodiment) and a predetermined potential by a charging roller 202 which is a roller-type charging member as a charging means. The charging roller 202 contacts the surface of the photosensitive drum 201 while being rotated in an arrow direction in FIG. 7 with rotation of the photosensitive drum 201, and charges the surface of the photosensitive drum 201.

The charged surface of the photosensitive drum 201 is subjected to a scanning exposure by an exposure device (laser scanner device) 203 as an exposure device, so that an electrostatic latent image (electrostatic image) is formed on the photosensitive drum 201. The exposure device 203 irradiates the surface of the photosensitive drum 201 with a laser beam L modulated depending on image data sent from an external device such as a personal computer to the image forming apparatus 200.

The electrostatic latent image formed on the photosensitive drum 201 is developed (visualized) by being supplied with toner T as a developer by a developing device 204 as a developing means, so that a toner image (toner picture, developer image) is formed on the photosensitive drum 201. The developing device 204 deposits the toner, conveyed by a developing roller 204a contacting the photosensitive drum 201, on the electrostatic latent image on the photosensitive drum 201. During development, to the developing roller 204a, a predetermined developing voltage is applied by a developing high-voltage power source (not shown) as a developing high-voltage applying means. In this embodiment, on an exposed portion (image portion) on the photosensitive drum 201 lowered in absolute value of a potential by being exposed to light after being charged uniformly, toner T charged to the same polarity (negative polarity in this embodiment) as a charge polarity of the photosensitive drum 201 is deposited (reverse development type).

A transfer roller 205 which is a roller-type member as a transfer means is provided so as to contact the photosensitive drum 201. The transfer roller 205 contacts the photosensitive drum 201 and forms a transfer portion (transfer nip) N. The toner image formed on the photosensitive drum 201 is transferred in the transfer position Pd, onto a sheet-like recording material S such as paper nipped and fed by the photosensitive drum 201 and the transfer roller 205. During transfer, to the transfer roller 205, a predetermined transfer voltage of an opposite polarity (positive polarity in this embodiment) to a normal charge polarity (principal charge polarity during the development) of the toner is applied. The recording material S is fed from a cassette 206 as a recording material accommodating portion by a feeding roller 207 or the like as a feeding means, and is conveyed to the transfer portion N by a conveying roller 208 or the like as a conveying means while being timed to the toner image on the photosensitive drum 201.

The toner image on which the toner image is transferred is sent to a fixing device 209 as a fixing means. The fixing device 209 applies heat and pressure to the recording material S on which an unfixed toner image is carried, and fixes (melts, sticks) the toner image on the recording material S. The recording material S on which the toner image is fixed is discharged to an outside of the image forming apparatus 200.

Further, toner (transfer residual toner) remaining on the photosensitive drum 201 without being transferred onto the recording material S during the transfer is recovered by the developing device 204. The transfer residual toner deposited on the photosensitive drum 201 is transferred onto the developing roller 204a by a potential difference between the potential of the photosensitive drum 201 and the developing voltage, and is recovered from the developing roller 204a into the developing device 204, and then is used again for image formation. Thus, in this embodiment, the image forming apparatus 200 has a cleaner-less constitution in which a dedicated cleaning device for removing the transfer residual toner from the surface of the photosensitive drum 201 is not provided.

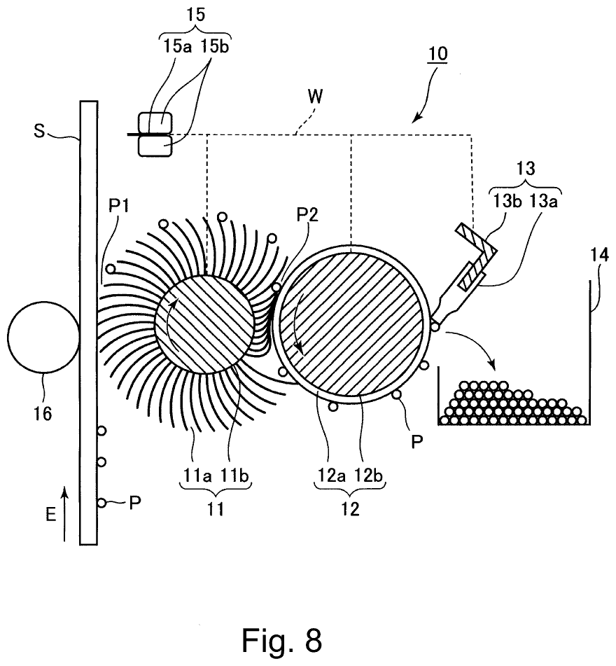

In the image forming apparatus 200 in this embodiment, the surface of the photosensitive drum 201 directly contacts the recording material S, and therefore, paper powder P (FIG. 8) is liable to be deposited on the surface of the photosensitive drum 201. In the paper powder P, in addition to pulp fibers (cellulose derived from broad-leaved tree or needle-leaved tree), a filler for making paper transparent or white, an internal sizing agent for preventing bleeding of ink, an internal sizing fixing agent for attracting the internal sizing agent to the pulp fibers, and the like are contained. Of these substances, substances having a possibility of having the influence particularly on the electrophotographic process are the pulse fibers and the filler. When the paper powder P is recovered together with the toner T, remaining on the photosensitive drum 201, into the developing device 204, the paper powder P causes image defect in some cases. That is, when the paper powder P is recovered into the developing device 204, a charge amount of the toner in the developing device 204 is lowered in some instances. Then, when the image forming operation is repeated in such a state, the charge amount of the toner in the developing device 204 becomes insufficient relative to a charge amount necessary for the image forming operation. When the toner charge amount becomes insufficient, a fog such that the toner is deposited in a thin layer on a region (non-image portion) on the photosensitive drum 201 where the image is not originally formed occurs in excess of an allowable range in some cases.

Therefore, the image forming apparatus 200 in this embodiment includes a paper powder collecting device 10, constituted by the electrostatic collecting device according to the present invention, for collecting the paper powder P as a substance-to-be-collected from the surface of the recording material S as an object-to-be-cleaned. In this embodiment, the paper powder collecting device 10 is provided in a feeding/conveying portion of the recording material S. More specifically, in this embodiment, the paper powder collecting device 10 is disposed on a side downstream of the cassette 206 and upstream of the transfer portion N with respect to a conveying direction of the recording material S. The paper powder collecting device 10 collects the paper powder P, charged to the positive polarity from the surface of the recording material S. By this, it is possible to suppress occurrence of the fog as described above.

Incidentally, the paper powder collecting device 10 may be constituted so as to also have a function of the conveying means of the recording material S.

### (2) General Structure of Paper Powder Collecting Device

Next, the paper powder collecting device 10 of this embodiment will be described. FIG. 8 is a schematic sectional view (showing a cross section substantially perpendicular to a rotational axis direction of a brush roller 11 described later) of the paper powder collecting device 10. A principle of a cleaning operation (paper powder collecting operation) by the paper powder collecting device 10 is similar to that of the cleaning device 100 of the embodiment 1. In the paper powder collecting device 10 of this embodiment, elements having functions or constitutions identical to or corresponding to those of the cleaning device 100 of the embodiment 1 are represented by the same reference numerals or symbols and will be appropriately omitted from detailed description. In this embodiment, the conveying direction of the recording material S conveyed from the cassette 206 toward the transfer portion N is a movement direction of the object-to-be-cleaned relative to the paper powder collecting device 10, i.e., an object-to-be-cleaned movement direction E. As in the case of the recording material S in this embodiment, in the case where the electrostatic collecting device according to the present invention is used in an industrial product, the object-to-be-cleaned movement direction is determined in many instances.

The paper powder collecting device 10 of this embodiment includes the brush roller 11 which is a rotatable collecting body as a collecting means, a recovering roller 12 which is a first removing member (rotatable recovering body) as a removing means, a cleaning blade 13 which is a second removing member (scraping-off member) as the removing means, an accommodating container 14 for accommodating the paper powder P, a charge-removing portion 15, and an opposite roller 16 for conveying the recording material S such as paper.

To the brush roller 11, from a motor (not shown) as a driving source constituting a driving means provided in the image forming apparatus 200, a driving force is transmitted by a drive transmitting member (not shown), so that the brush roller 11 is rotated in an arrow direction (clockwise direction) in FIG. 8 at a peripheral speed (the same speed as a conveyance speed of the recording material S) of 140 mm/sec. That is, the brush roller 11 is rotated so that the movement direction of the raisings 11a and the object-to-be-cleaned movement direction (recording material S conveyance direction) E become the same direction (forward direction) in a contact portion (collecting portion) P1 between the raisings 11a and the recording material S.

Further, to the recovering roller 12, from a motor (not shown) as a driving source constituting a driving means provided in the image forming apparatus 200, a driving force is transmitted by a drive transmitting member (not shown), so that the brush roller 11 is rotated in an arrow direction (counterclockwise direction) in FIG. 8 at a peripheral speed of 140 mm/sec. That is, the recovering roller 12 is rotated so that the movement direction of the raisings 11a of the brush roller 11 and the surface movement direction of the recovering roller 12 become the same direction (forward direction) in a contact portion (recovering portion) P2 between the raisings 11a of the brush roller 11 and the recovering roller 12. The brush roller 11 rubs the surface of the recording material S and the paper powder P on the recording material S by stroking the surface of the recording material S with the raisings 11a of the brush roller 11 contacting the surface of the recording material S while being rotated, and thus collects the paper powder P from the surface of the recording material S by an electrostatic depositing force. In this embodiment, the raisings 11a of the brush roller 11 function as a collecting member for rubbing the recording material S in contact with the recording material S. The paper powder P collected on the brush roller 11 is recovered by the electrostatic depositing force on the rotating recovering roller 12 while contacting the brush roller 11. In this embodiment, the surface layer 12a of the recovering roller 12 functions as a recovering member for recovering the paper powder P from the raisings 11a of the brush roller 11. The paper powder P recovered on the recovering roller 12 is scraped off by the cleaning blade 13 and is accommodated in the accommodating container 14.

Constitutions of the brush roller 11, the recovering roller 12, and the cleaning blade 13 in the paper powder collecting device of this embodiment are similar to those in the embodiment 1, so that detailed description thereof will be omitted. However, in this embodiment, a length of each of the brush roller 11 (region in which the raisings 11a are provided) and the recovering roller 12 (the surface layer 12a) in the longitudinal direction (rotational axis direction) is set to 220 mm so as to cover a while area of a widthwise direction substantially perpendicular to the conveying direction of an A4-sized recording material S. Further, in this embodiment, the opposite roller 16 is disposed opposed to the brush roller 11 so as to nip and convey the recording material S in cooperation with the brush roller 11. The opposite roller 16 may be rotationally driven or may be rotated by rotation of another member.

Further the paper powder collecting device 10 of this embodiment includes the charge-removing portion 15 provided in a position on a side downstream of the brush roller 11 (and upstream of the transfer portion N) with respect to the object-to-be-cleaned movement direction (recording material S conveying direction) E. That is, the charge-removing portion 15 is disposed in a position on a side downstream of the collecting portion P1 (and upstream of the transfer portion N) with respect to the object-to-be-cleaned movement direction (recording material S conveying direction) E. The charge-removing portion 15 constitutes a charge-removing means for charge-removing the recording material S rubbed and charged by the brush roller 11. Details of the charge-removing portion 15 in this embodiment will be described later.

### (3) Charge-Removing Means

Next, the charge-removing portion 15 as the charge-removing means in this embodiment will be further described.

First, the reason why the charge-removing means for charge-removing the recording material S in necessary for the paper powder collecting device 10 used in the image forming apparatus 200 will be described. The brush roller 11 can cause a strong electrostatic depositing force to act on the paper powder P, while the brush roller 11 exchanges the electric charge with the recording material S, and thus the recording material P is once charged to the positive polarity. When the positively charged recording material S is supplied to the transfer portion N as it is, the surface of the photosensitive drum 201 is charged to the negative (-polarity) potential by the charging roller 202, and therefore, a potential difference therebetween becomes large. As a result, the paper powder P remaining on the recording material P without being completely removed by the paper powder collecting device 10 is attracted to the surface of the photosensitive drum 201. This attracted paper powder P is deposited on the photosensitive drum 201 and is recovered by the developing device 204, and thus a charge amount of the toner in the developing device 204 is lowered, so that as described above, sooner or later, the fog image is generated in some cases. Accordingly, it is desirable that the recording material S is quickly charge-removed after passing through the collecting portion P1 which is the contact portion between the raisings 11a of the brush roller 11 and the recording material S.

In this embodiment, the charge-removing portion 15 is constituted by a charge-removing needle 15a as a charge-removing member and a charge-removing needle supporting portion 15b for supporting the charge-removing needle 15a. The charge-removing needle 15a is sandwiched and supported by the charge-removing needle supporting portion 15b. A constitution of the charge-removing needle supporting portion 15b is similar to the charge-removing cloth supporting portion 15b in the embodiment 1. In this embodiment, the charge-removing needle 15a as the charge-removing member is formed of a 0.1 mm-thick plate material constituted by SUS (stainless steel) which is an electroconductive metal material as an electric conductor. A shape of the charge-removing needle 15a in this embodiment is similar to the shape of the charge-removing cloth 15a in the embodiment 1. That is, a shape of a free end portion of the charge-removing needle 15a opposing the recording material S is a sawtooth shape as shown in FIG. 5. In this embodiment, at the free end portion of the charge-removing needle 15a opposing the recording material S, a pitch La of mountains 15a1, a height Lb of the mountains 15al, and a distance Lc between a top 15a2 of the mountain 15al are the same as those in the embodiment 1.

The charge-removing needle 15a is disposed along a direction crossing (typically, perpendicular to) the object-to-be-cleaned movement direction (recording material S conveying direction) E, i.e., a direction substantially parallel to the rotational axis direction of the brush roller 11. Further, in this embodiment, the length of the charge-removing needle 15a in the longitudinal direction is set to 225 mm longer than a length of a region in which the raisings 11a of the brush roller 11 are provided (and further, the length of the surface layer 12a of the recovering roller 12) in the longitudinal direction. That is, in the longitudinal direction of the charge-removing needle 15a, the region in which the raisings 11a of the brush roller 11 are provided (and further, the surface layer 12a of the recovering roller 12) falls inside the charge-removing needle 15a. By this, the recording material S can be charge-removed in a whole area of the recording material S with respect to the widthwise direction of the recording material S. Further, similarly as in the embodiment 1, the charge-removing needle 15a is electrically connected by wiring W to the core portion 11b of the brush roller 11 formed of the electric conductor, the base portion 12b of the recovering roller 12, and the cleaning blade supporting portion 13b so as to have the same potential as the potential of these electric conductor portions.

### (4) Evaluation Experiment

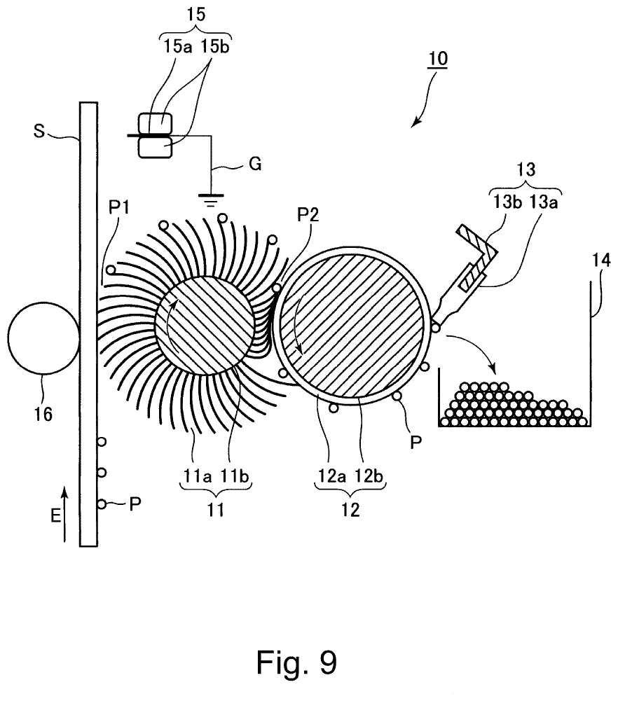

In order to verify an effect of this embodiment, comparison verification is conducted between the constitution of this embodiment and a constitution of each of a comparison example 3 and a comparison example 4. The constitution of the comparison example 3 is a constitution in which the charge-removing portion 15 in the constitution of this embodiment is not provided. The constitution of the comparison example 4 is a constitution in which as shown in FIG. 9, the charge-removing needle 15a of the charge-removing portion 15 having the same constitution similar to the constitution of this embodiment is connected to the ground potential (GND) (is electrically grounded). The constitutions of the comparison example 3 and the comparison example 4 are substantially the same as the constitution of this embodiment except for the above-described points. Also, as regards the comparison example 3 and the comparison example 4, elements having functions or constitutions, which are identical to or corresponding to those of this embodiment will be described by adding thereto the same reference numerals or symbols.

An experiment was conducted in the following manner. First, a potential of the charge-removing needle 15a after images were formed on 100 sheets of the recording materials S by a normal printing operation (sheet passing) was measured. Further, in order to evaluate an amount in which the paper powder P was recovered in the developing device 204, a fog amount (%) after the images were formed on 3000 sheets of the recording materials S (sheet passing) was measured. The fog amount (%) can be calculated by a difference between a reflected light quantity of a portion where the fog does not generate and reflected light quantity of a portion where the fog generates. The portion where the fog does not generate refers to a portion where a part of the recording material S on a print surface side is subjected to masking with a tape or the like and then, the moving is peeled off after the printing (image formation). The reflected light quantity of the portion where the fog does not generate is taken as 100%, and in the case where the reflected light quantity of the portion where the fog generates is 95%, the fog amount is 5%. As a measuring device of the reflected light quantity. “DENSHITOMETER TC-6DS”, manufactured by Tokyo Denshoku Co., Ltd. was used. As regards the fog amount, about 3% or less is an allowable level.

A result thereof is shown in a table 3.

TABLE 3

| | COMP. | COMP. | |
|---|---|---|---|
| | EX. 3 | EX. 4 | EMB. 2 |
| CRNP*¹ | — | 0 V | −500 V |
| FA*² | 7% | 5% | 2% |

*¹“CRNP” is a charge-removing needle potential after sheet passing of 10 sheets.
*²“FA” is the fog amount after sheet passing of 3000 sheets.

In the constitution of the comparison example 3, the fog amount increased up to 7% and exceeded the allowable level.

In the constitution of the comparison example 4, the potential of the charge-removing needle 15a is always kept at zero. Further, in the constitution of the comparison example 4, the fog amount increased up to 5% and exceeded the allowable level. This would be considered because the recording material S after passing through the brush roller 11 is not sufficiently charge-removed and an amount in which the paper powder P is recovered in the developing device 204 by the above-described mechanism is large.

On the other hand, in this embodiment, the potential of the charge-removing needle 15a after the printing operation was −500 V. Further, in this embodiment, the fog amount was 2% and fell within the allowable level. The reason why a degree of the fog is improved is based on a decrease in amount in which the paper powder P is recovered in the developing device 204. In this embodiment, the charge-removing needle 15a is connected to the above-described electric conductor portions, so that the potential difference between the charge-removing needle 15a and the recording material S is increased and the generation of the electric discharge from the charge-removing needle 15a is accelerated, and thus, an effect of lowering the positive potential of the recording material S increases. By this, it is possible to decrease the amount of the paper powder P recovered in the developing device 204 by the above-described mechanism.

Thus, in this embodiment, by electrically connecting the charge-removing needle 15a so as to have the same potential as the potential of the above-described electric conductor portions, a charge-removing effect of the charge-removing needle 15a is promoted, so that a higher charge-removing performance can be obtained.

Incidentally, in this embodiment, the constitution in which the charge-removing needle was used as the charge-removing member was described, but the present invention is not limited thereto. For example, a constitution of a corona charger using a charge-removing wire as a charge-removing member (electric discharging member) may be used. In this case, as the charge-removing wire, an arbitrary wire capable of being used as the charge-removing wire of the corona discharger can be used, but for example, a tungsten wire of about 30 μm in thickness can be suitably used. Further, as the charge-removing member, a charge-removing cloth similar to the charge-removing cloth of the embodiment 1 may be used. In this case, aggregate (non-woven fabric) prepared by assembling acrylonitrile-copper sulfide fibers similar to that of the embodiment 1 can be suitably used. Further, the charge-removing member such as the charge-removing needle may be connected (electrically grounded) to the ground potential (GND) through a current suppressing element so that a potential of the charge-removing member such as the charge-removing needle does not become excessively high to a certain degree or more. As the current suppressing element, it is possible to use Zener diode, varistor, resistance element, and the like. By this, it is possible to suppress electric discharge or the like from the charge-removing member toward members in the image forming apparatus. As a result, for example, it is possible to reduce a risk of occurrence of inconveniences such as an image defect. For example, from a viewpoint such that not only effective electric discharge of an object-to-be-cleaned is enabled but also an excessive increase in potential of the charge-removing member (electric conductor portion) is suppressed, the potential of the charge-removing member may suitably be about −100 V to −1000 V (negative potential of 100 V or more and 1000 V or less in terms of an absolute value), more preferably be −200 V to −500 V (negative potential of 200 V or more and 500 V or less in terms of an absolute value).

As described above, according to this embodiment, in the above-described paper powder collecting device 10, the recording material S charged by being rubbed with the raisings 11a of the brush roller 11 can be efficiently charge-removed. By this, it is possible to suppress that the paper powder P remaining on the recording material S without being collected is deposited from the recording material S onto the photosensitive drum 201 and then is recovered into the developing device 204, or the like. As a result, it is possible to suppress occurrence of the fog due to a lowering in charge amount of the toner in the developing device 204.

### Embodiment 3

Next, another embodiment of the present invention will be described. Also, in this embodiment, similarly as in the embodiment 2, an electrostatic collecting device according to the present invention is used as the paper powder collecting device in the image forming apparatus.

In the image forming apparatus and the paper powder collecting device of this embodiment, elements having functions or constitutions identical to or corresponding to those of the image forming apparatus and the paper powder collecting device of the embodiment 2 are represented by the same reference numerals or symbols and will be appropriately omitted from detailed description.

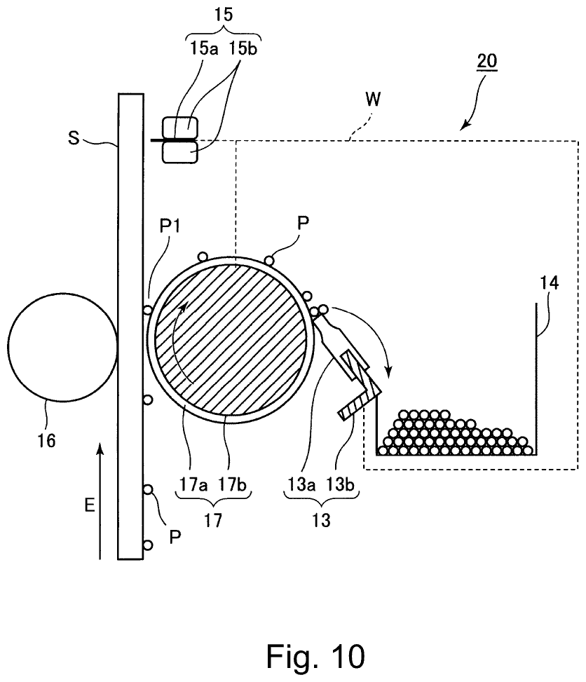

FIG. 10 is a schematic sectional view (showing a cross section substantially perpendicular to the rotational axis direction of a collecting roller 17) of a paper powder collecting device 20 of this embodiment.

The paper powder collecting device 20 of this embodiment is different from the paper powder collecting device 10 of the embodiment 2 in that the collecting roller 17 having a constitution similar to the constitution of the recovering roller 12 in the embodiment 2 is used as a collecting means for rubbing the object-to-be-cleaned by being rotated in contact with the object-to-be-cleaned on which the substance-to-be-collected is deposited. Further, in this embodiment, as a removing means for removing, from a surface of the collecting roller 17, the paper powder P as the substance-to-be-collected deposited on the surface of the collecting roller 17, only a cleaning blade 13 having a constitution similar to the constitution of the cleaning blade 13 in the embodiment 2 is provided. Constitutions of the accommodating container 14, the charge-removing portion 15, and the opposite roller 16 are the same as those in the embodiment 2. According to this embodiment, compared with the constitution of the embodiment 2, in a constitution in which the number of component parts is small, a high effect can be obtained.

A constitution of the collecting roller 17 as the collecting means in this embodiment is substantially the same as the constitution of the recovering roller 12 in the embodiment 2. That is, the collecting roller 17 in this embodiment includes a surface layer 17a having the substantially same constitution as the surface layer 12a of the recovering roller 12 in the embodiment 2 and a base portion 17b having the substantially same constitution as the base portion 12b of the recovering roller 12 in the embodiment 2.

In this embodiment, the surface layer 17a of the collecting roller 17 functions as the collecting member for rubbing the recording material S in contact with the recording material S. Further, in this embodiment, the collecting roller 17 is constituted by covering the surface of the base portion 17b, formed of the electric conductor, with the surface layer 17a formed of the insulator.

To the collecting roller 17, from a motor (not shown) as a driving source constituting a driving means provided in the image forming apparatus 200, a driving force is transmitted by a drive transmitting member (not shown), so that the brush roller 11 is rotated in an arrow direction (clockwise direction) in FIG. 8 at a peripheral speed (the same speed as a conveyance speed of the recording material S) of 140 mm/sec. That is, the collecting roller 17 is rotated so that the movement direction of the surface of the collecting roller 17 and the object-to-be-cleaned movement direction (recording material S conveyance direction) E become the same direction (forward direction) in a contact portion (collecting portion) P1 between the collecting roller 17 and the recording material S. The collecting roller 17 rubs the surface of the recording material S and the paper powder P on the recording material S while the collecting roller 17 conveys the recording material S in cooperation with the opposite roller 16 while being rotated, and collects the paper powder P from the surface of the recording material S by an electrostatic depositing force.

As a point different from the embodiment 2, it is possible to cite that the surface of the collecting roller 17 as the collecting means is a smooth surface. When the surface of the collecting means is the smooth surface, a constitution of the removing means for removing the substance-to-be-collected, deposited on the surface of the collecting means, from the collecting means can be simplified. Typically, as in this embodiment, by the cleaning blade 13, it is possible to directly scrape off the substance-to-be-collected from the collecting means.

Further, similarly as in the case of the surface layer 12a of the recovering roller 12 in the embodiment 2, in the case where the surface layer 17a of the collecting roller 17 and the paper powder P rub each other, the paper powder P is positively charged, and the surface layer 17a of the collecting roller 17 is negatively charged. In this embodiment, as a material of the surface layer 17a of the collecting roller 17, fluorine-containing resin of which position in the triboelectric charge series in on a most negative side (or in a position close to an end of the negative side) is used. For that reason, in the case where the fluorine-containing resin and the paper powder P on the recording material S directly rub each other, between both members, an electrostatic depositing force stronger than that in the case of the PET constituting the raisings 11a of the brush roller 11 in the embodiment 2 can be generated.

Further, the constitution of the charge-removing portion 15 in this embodiment is the same as that in the embodiment 2, and therefore, also in this embodiment, an effect which is the same as the effect obtained by the charge-removing portion 15 in the embodiment 2 can be obtained.

Incidentally, a material of the surface layer of the collecting roller in the case where the collecting roller is used as in this embodiment may preferably be the fluorine-containing resin is preferred from a viewpoint of the collecting performance, but is not limited thereto. For example, a material exemplified as the material of the raisings of the brush roller in the embodiment 1 may be used, and a material exemplified as the material of the surface layer of the recovering roller in the embodiment 1 may be used.

Thus, in this embodiment, the rotatable collecting body (collecting roller) 17 is constituted by a roller including the surface layer 17a constituting the collecting member and the base portion 17b provided inside the surface layer 17a. Further, in this embodiment, the charge-removing member (charge-removing needle) 15a is electrically connected to an electric conductor constituting at least a part of the base portion 17b. Further, in this embodiment, the removing member 13 is constituted by a blade (cleaning blade) for removing the substance-to-be-collected (paper powder) P from the collecting member (surface layer) 17a. Further, in this embodiment, the charge-removing member 15a is electrically connected to an electric conductor constituting at least a part of the blade 13. Further, in this embodiment, the charge-removing member 15a is constituted using a metal plate. Further, in this embodiment, the paper powder collecting device 20 collects the paper powder P as the substance-to-be-collected from the surface of the recording material S as the object-to-be-cleaned in the image forming apparatus 200 for forming an image by transferring a toner image, formed on the image bearing member 201, onto the recording material S.

As described above, according to this embodiment, compared with the constitution of the embodiment 2, by a simple constitution, it is possible to obtain a stronger electrostatic depositing force of the collecting member (the surface layer 17a of the collecting roller 17).

### Other Embodiments

In the above, the present invention was described in accordance with specific embodiments, but the present invention is not limited to the above-described embodiments.

In the above-described embodiments, the rotatable collecting body and the rotatable recovering body were the brush roller or the roller, but a rotatable collecting body and a rotatable recovering body which are constituted by an endless belt member may also be used. For example, as the rotatable collecting body, a belt member including the raisings as the collecting member can be used, or a belt member including a surface layer having a smooth surface as the collecting member can be used. In this case, for example, of a plurality of stretching rollers for stretching the belt member, at least one stretching roller is constituted by an electric conductor, and this electric conductor can be connected to the charge-removing member.

Further, as the rotatable collecting body in the cleaning device of the embodiment 1, a paddle roller provided with a plurality of sheets as the collecting member at an outer periphery of a core portion thereof along a rotational axis direction of the core portion.

Further, the rotatable collecting body and the rotatable recovering body in the embodiment 1 were driven by the motor, but the present invention is not limited thereto. For example, a constitution in which the cleaning device is not provided with the driving source, such as a constitution in which the rotatable collecting body and the rotatable recovering body are rotated by transmitting thereto a rotational force of wheels rotated with movement of the cleaning device in contact with the object-to-be-cleaned, or the like constitution may also be employed.

Further, the cleaning device of the embodiment 1 was a cleaning device used by being placed on the floor surface and then by being pushed forward, but may also be a hand-held cleaning device (cleaner, hand-held cleaner) designed light-weighted. Also, in this case, depending on a mounting position and a shape of the handle, a cleaning direction (i.e., object-to-be-cleaned movement direction) can be assumed in advance.

Further, in the embodiments 2 and 3, the image forming apparatus in which the electrostatic collecting device was used was the monochromatic image forming apparatus, but for example, the image forming apparatus may also be a color image forming apparatus including a plurality of image forming portions each provided with an image bearing member.

Further, the electrostatic collecting device according to the present invention can be used for various purposes other than the purposes mentioned in the above-described embodiments. For example, the electrostatic collecting device according to the present invention can be used for collecting the paper powder deposited on the surface of the image bearing member by constituting the electrostatic collecting device so that the rotatable collecting body is contacted to the image bearing member in the image forming apparatus.

In this case, the image bearing member is not limited to the photosensitive drum, but may also be an intermediary transfer belt or the like for conveying the toner image, primarily transferred from the photosensitive drum, for secondary transferring the toner image onto the recording material. Further, the electrostatic collecting device according to the present invention can be used for collecting the paper powder from a surface of a roller or a belt for conveying the recording material by constituting the electrostatic collecting device so that the rotatable collecting body is contacted to the surface of the belt. Further, the electrostatic collecting device according to the present invention can be used as cleaning devices in various manufacturing facilities for cleaning glass substrates and various insulators or electric conductors as the object-to-be-cleaned, for example. For example, in the case where the electrostatic collecting device according to the present invention is used in such manufacturing facilities or the like, at least one of the electrostatic collecting device and the object-to-be-cleaned is moved in a predetermined direction, so that the object-to-be-cleaned movement direction is determined in many instances.

While the present invention has been described with reference to exemplary embodiments, it is to be understood that the invention is not limited to the disclosed exemplary embodiments. The scope of the following claims is to be accorded the broadest interpretation so as to encompass all such modifications 5 and equivalent structures and functions.

This application claims the benefit of Japanese Patent Application No. 2023-187242 filed on Oct. 31, 2023, which is hereby incorporated by reference herein in its entirety.

What is claimed is:

1. An electrostatic collecting device comprising:
a rotatable collecting body including a collecting member configured to form a collecting portion in contact with an object-to-be-cleaned and formed of an insulator, wherein the rotatable collecting body rubs the object-to-be-cleaned in the collecting portion with the collecting member by rotation thereof, and collects, in the collecting member, a substance-to-be-collected from the object-to-be-cleaned moved relative to the collecting portion;
a removing member configured to remove the substance-to-be-collected from the collecting member; and
a charge-removing member provided opposed to the object-to-be-cleaned on a side downstream of the collecting portion with respect to a movement direction of the object-to-be-cleaned relative to the collecting portion,
wherein the charge-removing member constitutes at least a part of at least one of the rotatable collecting body and the removing member, and
wherein the charge-removing member is electrically connected to an electric conductor which is in non-contact with the object-to-be-cleaned.

2. An electrostatic collecting device according to claim 1, wherein the rotatable collecting body comprises a brush roller including:
a core portion; and
a plurality of raisings provided on an outer periphery of the core portion and constituting the collecting member.

3. An electrostatic collecting device according to claim 2, wherein the charge-removing member is electrically connected to an electric conductor constituting the core portion.

4. An electrostatic collecting device according to claim 2, wherein the charge-removing member includes:
a first removing member configured to recover the substance-to-be-collected from the collecting member; and
a second removing member configured to remove the substance-to-be-collected, recovered from the collecting member in the first removing member, from the first removing member.

5. An electrostatic collecting device according to claim 4, wherein the charge-removing member is electrically connected to an electric conductor constituting at least a part of at least one of the first removing member and the second removing member.

6. An electrostatic collecting device according to claim 1, wherein the rotatable collecting body is constituted by a roller including a surface layer constituting the collecting member and a base portion provided inside the surface layer.

7. An electrostatic collecting device according to claim 6, the charge-removing member is electrically connected to an electric conductor constituting at least a part of the base portion.

8. An electrostatic collecting device according to claim 6, wherein the charge-removing member is constituted by a blade for removing the substance-to-be-collected from the collecting member.

9. An electrostatic collecting device according to claim 8, wherein the charge-removing member is electrically connected to an electric conductor constituting at least a part of the blade.

10. An electrostatic collecting device according to claim 1, wherein the charge-removing member is constituted by metal threads.

11. An electrostatic collecting device according to claim 1, wherein the charge-removing member is constituted by acrylonitrile-copper sulfide composite fibers.

12. An electrostatic collecting device according to claim 1, wherein the charge-removing member is constituted by using a metal plate.

13. An electrostatic collecting device according to claim 1, wherein an end portion of the charge-removing member opposing the object-to-be-cleaned is formed in a saw-tooth shape.

14. An electrostatic collecting device according to claim 1, further comprising a shielding portion configured to shield the rotatable collecting body from the charge-removing member.

15. An electrostatic collecting device according to claim 1, wherein the charge-removing member is disposed in a position apart from the rotatable collecting body by at least 30 mm.

16. An electrostatic collecting device according to claim 1, wherein a length of the charge-removing member in a longitudinal direction is longer than a length of a region, in which the collecting member is provided, in a direction substantially perpendicular to a circumferential movement direction of the collecting member by rotation of the rotatable collecting body.

17. An electrostatic collecting device according to claim 1, wherein a potential attenuation rate R₁ of a surface of the collecting member, after rotation through one full circumference, represented by the following formula (1) is 10% or less:
$${R}_{1} = 1 - exp ( - {t}_{1} / τ ) \qquad ( 1 )$$
wherein t₁ is a time required for the rotation of the collecting member through one full circumference, τ is potential attenuation time constant and is a time required for attenuating a surface potential of the collecting member to V₀×(1/e) when the surface of the collecting member is electrically charged to an initial potential V₀, and e is base of natural logarithm.

18. An electrostatic collecting device according to claim 1, wherein the electrostatic collecting device collects dust as the substance-to-be-collected from the object-to-be-cleaned.

19. An electrostatic collecting device according to claim 1, wherein the electrostatic collecting device collects paper powder as the substance-to-be-collected from a surface of a recording material as the object-to-be-cleaned in an image forming apparatus for forming an image on the recording material by transferring a toner image, formed on an image bearing member, onto the recording material.
